(19) United States
(12) Patent Application Publication
(10) Pub. No.: US 2008/0318648 A1
(43) Pub. Date: Dec. 25, 2008

(54) SELF-PROPELLED AGRICULTURAL HARVESTING MACHINE WITH LOSS-MEASURING DEVICE

(76) Inventors: Joachim Baumgarten, Beelen (DE); Markus Brune, Marienfeld (DE); Christian Zurhake, Visbeck (DE)

Correspondence Address: Striker, Striker & Stenby, 103 East Neck Road, Huntington, NY, 11743, US

(21) Appl. No.: 12/136,229

(22) Filed: Jun. 10, 2008

(30) Foreign Application Priority Data
Jun. 22, 2007 (DE) 10 2007 029 218.1

(51) Int. Cl. A01D 41/127

(52) U.S. Cl. 460/5

(57) ABSTRACT

A self-propelled harvesting machine has a cleaning device having sieves, a loss-measuring device for the sieves of the cleaning device, at least one sensor having a sensor surface and located at a back end of the cleaning device, and the sensor is located at an end of the cleaning device behind at least one of the sieves such that a crop material that fails on the sensor surface and is detected remains in the harvesting machine and is conveyed to a tailings device.

### CROSS-REFERENCE TO A RELATED APPLICATION

The invention described and claimed hereinbelow is also described in German Patent Application DE 10 2007 029 218.1 filed on Jun. 22, 2007. This German Patent Application, whose subject matter is incorporated here by reference, provides the basis for a claim of priority of invention under 35 U.S.C. 119(a)-(d).

### BACKGROUND OF THE INVENTION

The present invention is based, in general, on the field of agriculture and the processing of harvested crops.

Vehicles designed to pick up and process crops—in particular self-propelled agricultural harvesting machines—are used for this purpose. The self-propelled agricultural harvesting machines are typically combine harvesters that are equipped with devices for processing and conveying the crop material. The cleaning device, for instance, is a conveyance device of this type. The cleaning device is used to separate the crop material into the grain and non-grain portions. A cleaning device of this type is composed, e.g., of a blower, and an upper sieve and a lower sieve. The upper and lower sieve are designed as adjustable chaffers, through which an air flow produced by the fan flows. Large and lightweight non-grain portions are captured by the air flow before they reach the upper sieve, and they are ejected out of the combine harvester at the back end.

The oscillating motion of the sieves, and the air flow cause the grain and non-grain components to be directed toward the back end of the upper sieve. Depending on the adjustment of the upper sieve width, the grain portions and non-grain portions fall onto the lower sieve and over a sensor—which is composed of an impact element—out of the back end of the combine harvester. The impact element may contain one or more vibratory sound sensors for detecting the grain portions. The sensors detect the grain portions that do no fall through the upper sieve because they are attached to non-grain portions. This portion of the crop material that leaves the combine harvester is referred to as loss due to cleaning.

To register the losses due to cleaning, various self-propelled agricultural harvesting machines—combine harvesters, in particular—are known in the related art, which include a loss-measuring device for sieves of a cleaning device with at least one sensor located at the back end of the cleaning device. Basically, a loss-measuring device is composed of a sensor, the “impact element”, onto which the grain falls, a sound sensor, which detects the impact pulse, and evaluation electronics, which evaluate the analog signal of the sound sensor, in order to display the analog signal in a suitable manner, as information for the driver, in a loss display of an electronic fieldwork information system.

A sensor of this type is made known in DE 197 25 028 A1. This type of sensor has weak points in terms of detecting grain, however. For example, the sensor is greatly dependent on the longitudinal slant, given that it is screwed permanently to the frame of the machine. As a result, grain may fly over the sensor and go undetected. The sensor also has disadvantages when it is used to thresh rapeseed, because the grain is so lightweight that it is inadequately detected.

Publication EP 0 093 991 B1 discloses a grain-loss measuring device of this type for sieves of a cleaning device of combine harvesters, which includes sensors located at the back end of the cleaning device. The disadvantage of this placement of the sensors is that the grains that fall onto the sensor through the grid-like protective device fall to the ground after they are detected as cleaning loss, and they are not spread, thereby resulting in piles being formed. Due to these piles and the subsequent germination of the grains and growth of plants, undesired strips of green form on the field.

In other embodiments of the related art, the sensors are integrated in or over the conveying devices, e.g., the feed pan of the chaff spreader. Although this ensures that the grain is detected, it is distributed by the blower to the radial straw spreader. The radial straw spreader then spreads the grains—along with the straw—onto the harvesting width of the field. The chaff is transported from the chaff blower to the radial straw spreader through the air in a bundled stream. The radial straw spreader is provided with an opening in the direction of travel for picking up the chaff. Due to this design, pieces of grain and non-grain portions may be thrown back at high speed at any time and trigger further signals on the sensors. That is, due to the sifting of chaff and influences by the radial straw spreader or the feed pan, the measurements performed by the loss-measuring device may be negatively affected, and a higher loss due to cleaning may be ascertained and displayed than actually exists, which could result in a maladjustment of the cleaning sieves and/or the upper sieve width, which, in turn, results in more non-grain portions in the grain tank contaminating the crop material.

To further reduce and/or minimize the loss of crop material—e.g., corn, peas, beans, wheat, barley, rye, rapeseed, and Italian ryegrass—during the cleaning procedure, it is necessary to more exactly define the impact point of the grain portions on the sensor and to keep them separated from the non-grain portions.

### SUMMARY OF THE INVENTION

The present invention is therefore based on the object of creating a loss-measuring device of the type described initially that prevents the aforementioned disadvantages of the known designs of the related art, and to provide a technical solution that makes it possible to support and/or simplify the cleaning procedure, in order to prevent a loss of grain portions due to poorly positioned sensors.

In keeping with these objects and with others which will become apparent hereinafter, one feature of the present invention recites, briefly stated, a self-propelled harvesting machine, comprising a cleaning device having sieves; a loss-measuring device for said sieves of said cleaning device; at least one sensor having a sensor surface and located at a back end of said cleaning device, said sensor being located at an end of said cleaning device behind at least one of said sieves such that a crop material that fails on the said sensor surface and is detected remains in the harvesting machine and is conveyed to a tailings device.

The placement of the sensor at the end of the cleaning device behind at least one sieve such that the grain portions that fall on the sensor surface and are detected remain in the harvesting machine and are conveyed to a tailings device offers the advantage, in particular, that these grain portions may be separated out later and are not ejected via the chaff spreader onto the ground as a loss, thereby ensuring that only the non-grain portions reach the chaff blower.

In an advantageous refinement, the sensor surface is not parallel with the surface of a rake that adjoins at least one sieve. The angle between the two surfaces is adjusted such that the sensor surface points away from the radial straw spreader and points toward the cleaning device. Via this configuration and position of the sensor, the risk is greatly reduced that chaff and/or straw portions thrown back by the chaff spreader and/or the radial straw spreader will strike the sensor surface and affect the measured results. A maladjustment of the sieve widths and the throughput is therefore prevented.

Due to the grain portions from the upper sieve passing through the rake and striking the sensor surface, the impact speed of the grain portions for producing a large amplitude of a damped oscillation for detection with a vibration sound sensor is the determining factor for the amplitude, and it is easily influenced by a change in the height from which the grain falls. The impact position of the grain portion also strongly influences the sensor signal. The further the impact point of the grain is from the sensor, the smaller the amplitude. Due to the small drop height and the inclined position of the sensor surface, erroneous measurements of grain portions caused by the longitudinal slant of the self-propelled agricultural machine relative to the sensor during harvesting are ruled out. Sensor surfaces that are parallel with the rake surface or other surfaces of the sieve have the disadvantage that they depend on the longitudinal slant of the harvesting machine. When harvesting is performed on hillsides, the machine slants longitudinally, and the grain portions fly behind the sensor surface and may therefore not be detected, thereby also resulting in erroneous measurements.

The permanent return of grain portions into the tailings is attained by the fact that a one-piece or multiple-piece sensor holder with several functional sections was developed for mounting the sensor according to the present invention. The preferably three functional sections include at least one opening, at least one fastening element, and at least one guide element. The opening advantageously serves to accommodate the sensor. The fastening element advantageously serves to attach the sensor holder on a feed pan of a chaff blower. The guide element is advantageously stepped in design, similar to stairs. In an advantageous refinement, a movable extension mat, preferably a rubber element, is located on at least one end of the guide element, the movable extension mat creating a movable connection with the sieve pan end profile.

A support frame is located on the stepped guide element in order to limit the swinging motion of the sensor holder. The support frame may be attached to the steps using fastening means such as welding, soldering, screwing, riveting, or the like. The free ends of the support frame serve as an additional attachment for the sensor holder on the feed pan of the chaff spreader. In another design of the support frame, it also serves as an attachment to the sensor holder and, with its free ends, for attachment to an end profile that adjoins the upper or lower sieve, thereby eliminating an attachment of the support frame to the feed pan.

The extension mat and the stepped guide element form a type of guide surface for an air flow that is created by a cleaning fan and passes between the lower sieve and the sieve pan profile, thereby ensuring that the air stream flows over the loss-measuring device, and the grain portion that reaches the extension mat, guide surface, and sensor surface receives additional cleaning. The air flow separates the grain from the chaff. The chaff is conveyed to the chaff blower, and the grain is conveyed to the tailings. The grain portions that are returned in this manner are conveyed via the tailings to the threshing and cleaning process once more, thereby ensuring that piles do not form on the field. Due to the blower air directed on the extension mat and the stair surface and/or the stepped guide surface of the guide element, the adjoining sensor surface receives additional cleaning and/or is kept free of deposits.

Due to the evaluations of measured results obtained in impact trials of grain on the sensor surface, it was also noted that an impact element length of 60% of the width of the sieve pan is adequate for detecting grain losses of over 95%. It is therefore not necessary to locate a sensor along the entire width of the cleaning device. The required length and width of the sensor field may be subdivided into individual partial sensor surfaces along the width of the sensor, e.g., two, three, or four individual sensors, in order to attain specific findings about the transverse distribution of the cleaning losses. Using the information about the transverse distribution of the cleaning losses, it is possible to control the cleaning in a targeted manner at an early stage. Preferably, two partial sensors are distributed on the right and left over the width, and they are located at the end of the cleaning device, with each sensor length covering up to approximately 30% of the width of the sieve pan. More than 95% of the lost portions are therefore reliably detected.

The sensor surface and the sensor holder are advantageously connected with each other in a detachable or non-detachable manner. To prevent contaminations that may corrupt the measured result, it is important that a gap not form between the sensor surface and the sensor holder, in which grain may collect.

When the sensor holder is made, e.g., of a plastic material, the sensor surface may be connected with the sensor holder, e.g., via injection molding. The injection point may be obtuse or, to increase the strength of the connection, it may be designed with two flanges that are angled toward each other at right angles. That is, a right-angled flange would be attached at an angle to the sensor surface, and the other right-angled flange would be attached at an angle to the sensor holder, so that the two flanges face each other with parallel surfaces, thereby resulting in a large, very strong connecting surface. The two flanges may also be connected via various fastening means, and they are preferably non-detachably connected via riveting, or detachably connected using screws. The seam that results between the two flanges in the form of a joint must be sealed, e.g., with an elastic material, to prevent contamination.

The loss-measuring device, which is located on the end of the cleaning device, performs—due to its location—the function of conveying the crop material that arrives in the tailings, and the sensor holder serves as an elastic and vibration-damping support for the sensor surface. The sensor holder may be composed of any material, such as metal or plastic. When the sensor holder is composed, e.g., of metal, the connection between the sensor surface inserted in the intended opening in the sensor holder is established using an elastic material. Elastic materials that may be used are, e.g., various silicones or, depending on which manufacturing method is used for assembly, materials that are used for vulcanization, e.g., EPDM (an ethylene propylene diene monomer mixture).

In addition, the sensor holder may have defined tapers in the material located circumferentially around the sensor surface, thereby enabling the sensor holder to be designed to be elastic and thereby improving the damping properties in a positive manner, so that fewer—and damped—vibrations generated by the harvesting machine influence the measured result of the sensor.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic depiction of a combine harvester with a loss-measuring device for the cleaning device,

FIG. 2 is a perspective illustration of a complete loss-measuring device,

FIG. 3 is a schematic depiction of a top view of the measurement devices that abut the end of the upper sieve and the underside of the rake, and

FIG. 4 is a schematic depiction of the detailed region “A” shown in FIG. 1.

### DESCRIPTION OF THE PREFERRED EMBODIMENTS

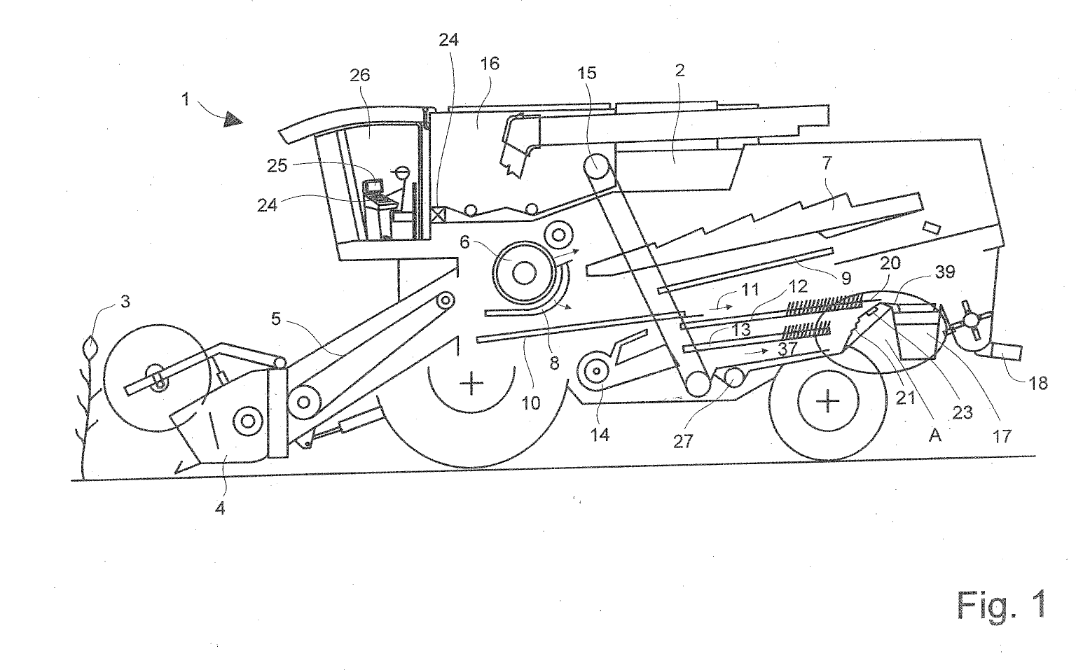

FIG. 1 is a schematic depiction of a self-propelled agricultural harvesting machine 1, which serves to pick up and process crop material 3. Self-propelled agricultural harvesting machine 1 is a combine harvester 2 equipped with a header 4, which—together with conveyor 5—conveys crop material 3 to cylinder 6, which is abutted by a tray-type shaker 7. A return pan 9 and a return device 10, which direct separated-out crop material 3 to a cleaning device 11 composed of an upper sieve 12 and a lower sieve 13, are located below concave 8 and tray-type shaker 7. Sieves 12, 13 are supplied with cleaning air, which is directed through and over sieves 12, 13 by a cleaning fan 14. Cleaned crop material 3 is conveyed by an elevator conveyor 15 into a grain tank 16, where it is collected. A crop material portion that is conveyed by tray-type shaker 7, e.g., straw, is directed via the rear part of combine harvester 2 to a radial spreader 18, which distributes the crop material portions onto the ground.

The crop material portions, e.g., chaff, that are transported via sieves 12, 13 via the motion of the sieves and the cleaning air to the back end of combine harvester 2 are directed via a grain pan 19—which is abutted on the right and left by a rake 20—a feed pan 39, and a chaff blower 17 to radial spreader 18, to be spread across the ground. A loss-measuring device 21, which detects the grain portions, is located directly below rake 20. A loss-measuring device 21 is basically composed of a sensor, the “impact element”, onto which the grain falls, a sound sensor 23, which detects the impact pulse, and evaluation electronics, which evaluate the analog signal of sound sensor 23, in order to display the analog signal in a suitable manner, as information in driver's cab 28 for the driver, in a loss display 25 of an electronic fieldwork information system 24. Loss-measuring device 21 is positioned such that the grain portions that leave the end of upper sieve 12 of cleaning device 11 do not slide backward and land on the ground to form piles, but instead strike the sensor surface in such a manner that they reach tailings 27.

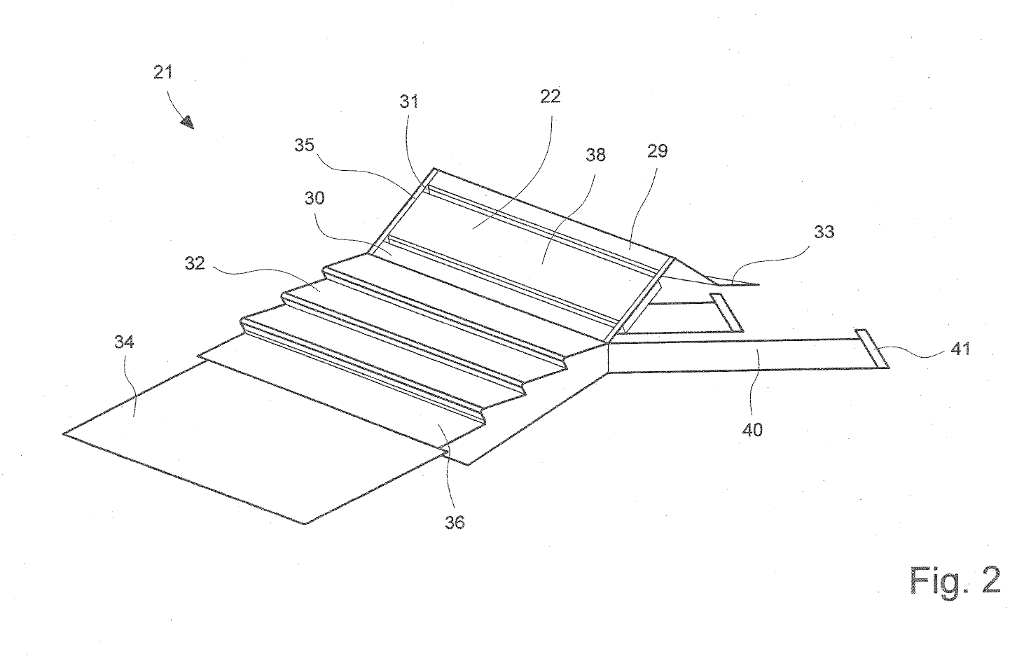

Inventive loss-measuring device 21 is shown in FIG. 2 in a perspective illustration. Loss-measuring device 21 is basically composed of a sensor holder 29 with three functional areas. The three functional areas of sensor holder 29 are formed by three individual parts, i.e., holding element 30, which includes an opening 31 for receiving sensor 22, stepped guide element 32, which is adjoined by an extension mat 34, and a fastening element 33, for the detachable attachment to a not-shown feed pan. Sensor holder 29 is preferably designed as a single-pieced stamped and bent element, or as an injection-molded part. The functional area with opening 31 supports sensor 22. The gap between sensor 22 and opening 31 of sensor holder 29 is filled with an elastic material 35, in order to reduce the acoustic waves of the harvesting machine when the grains are detected via vibration sensor 23. The adjacent functional area is formed by fastening element 33, which ensures a solid connection of sensor holder 29 with the feed pan of the chaff blower, or fastening element 33 is part of sensor holder 29. The third functional area is characterized by a guide element 32 that has a stepped designed composed preferably of three steps. The number of steps may vary, and they point in the direction of the cleaning device.

Stepped guide element 32 seamlessly abuts sensor 22, in order to prevent the build-up of crop material. An extension mat 34, which is preferably designed as a rubber mat, is attached to the other end of stepped guide element 32. It may be attached using various attachment means, e.g., screws, rivets, etc. Extension mat 34 forms—together with stepped guide element 32—a guide surface 36 for the air flow generated by the cleaning fan, and it forms a movable connection with the floor of the cleaning device, the sieve pan end profile. Due to guide surface 36, the air flow from the cleaning fan which flows over the lower sieve flows around sensor surface 38 of sensor 22. The air flow separates the grain from the chaff. The grain is conveyed to the tailings, and the chaff is conveyed via fastening element 33 to the feed pan of the chaff blower.

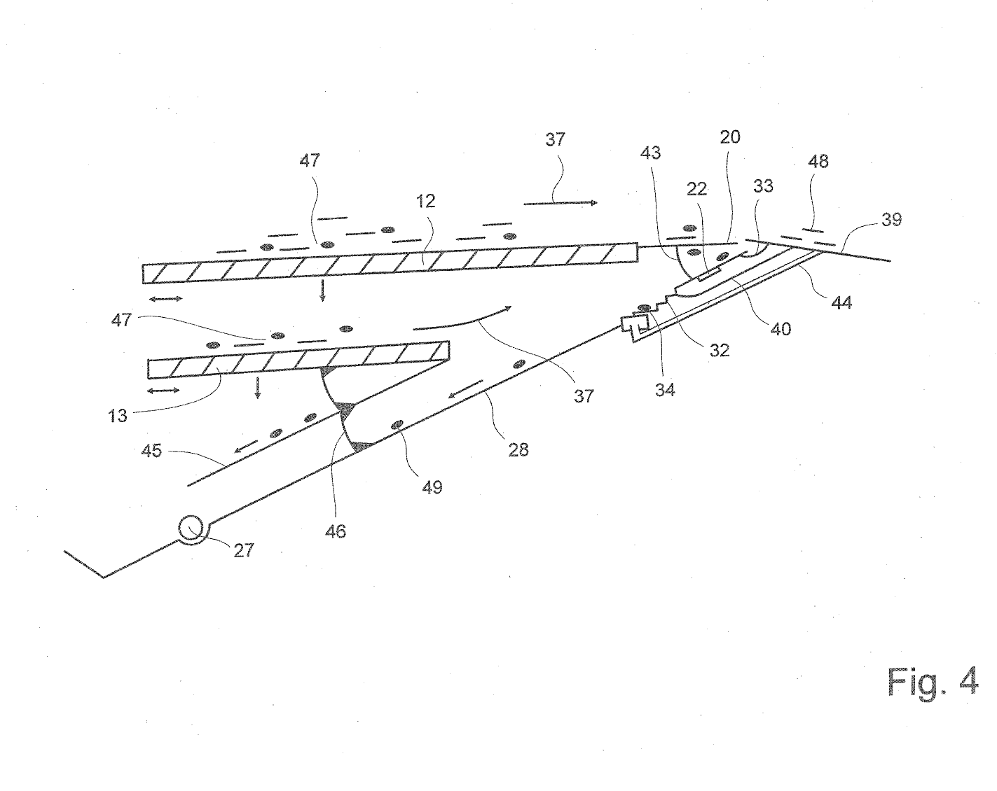

As shown particularly in conjunction with FIGS. 2 and 4, sensor surface 38 is angled such that loss-measuring device 21 is not positioned parallel with rake 20, but instead has an angle 43. According to the present invention, due to angle 43, sensor surface 38 does not point toward feed pan 39, but rather in the direction of cleaning device 11. As a result, the crop portions no longer land on the ground as loss. A support frame 40 is located on stepped guide element 32 to increase the strength of the attachment of sensor holder 29 on feed pan 39, and to reduce the vibrations of sensor 22. Support frame 40 is attached to guide element 32, e.g., via welding, although other types of attachment are possible, and it is also detachably connected with feed pan 39 via both free ends 41. One-piece support frame 40 is designed to match the shape of stepped guide element 32, although it may also include a raised edge region (not shown) for guiding the crop portions. Support frame 40 is also designed such that it fixes the angle in place that results between fastening element 33 and holding element 30. Support frame 40 fixes loss-measuring device 21 in a slanted position relative to rake 20, thereby enabling crop material portions 3 to return to tailings 27.

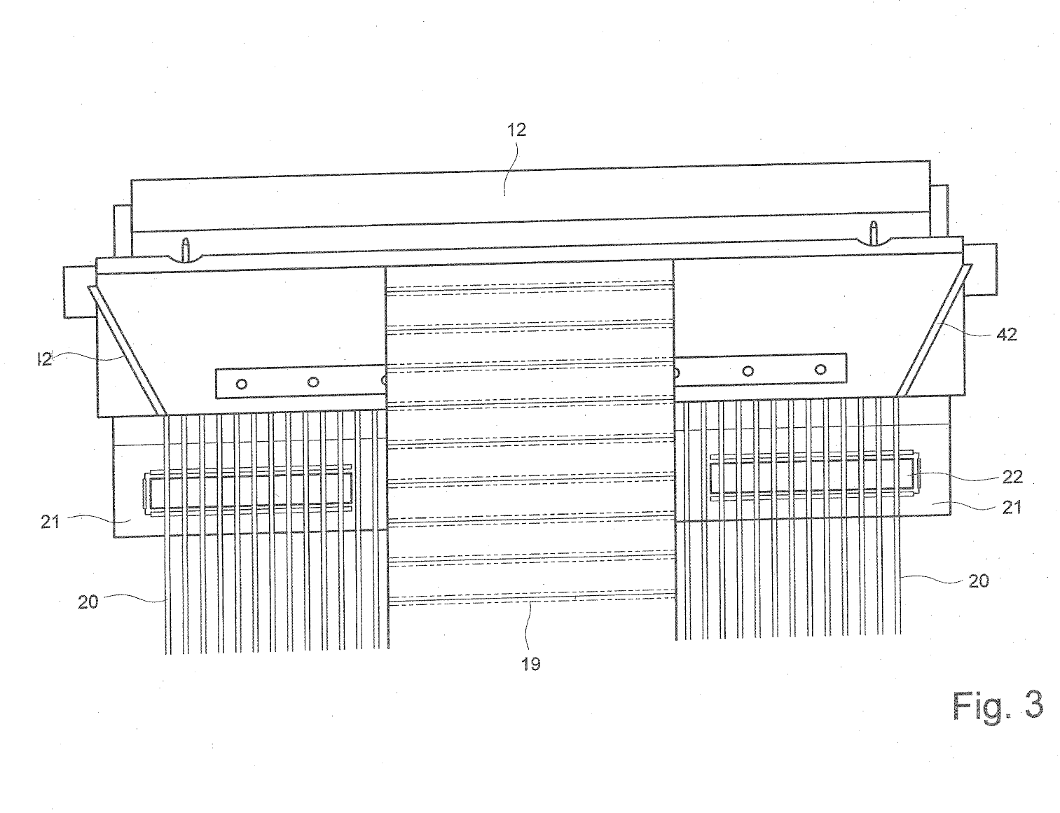

FIG. 3 is a schematic depiction and top view of the placement of both measuring devices 21 behind upper sieve 12 and to the right and left of grain pan 19, directly beneath rake 20. By dividing sensors 22 into two pieces, the adjustment of the cleaning device may be influenced even while harvesting on a flat surface when the crop material is distributed incorrectly on upper sieve 12. In addition, by locating guide plates 42 to the right and left of the outlet opening at the end of upper sieve 12, it is possible to form a constriction for the crop material. Via the constriction, it is ensured that crop material portions are conveyed toward sensors 22 even when harvesting is performed on an inclined surface.

FIG. 4 is a schematic illustration of the detailed area “A” in FIG. 1 with the slanted placement of the measuring device for conveying the crop material portions composed of grain 49 to tailings 27. A clean grain return floor 45, which is connected via a coupling element 46 with lower sieve 13, is also shown. Coupling element 46 also establishes a connection with floor 28. In turn, floor 28 is connected—as is the loss-measuring device—with feed pan 39 at its rear end via fastening elements 44. A further connection between the loss-measuring device—composed of sensor 22, guide element 32 and extension mat 34, and feed pan 39—is formed by fastening element 33. As an alternative, the loss-measuring device is not attached via fastening element 33 and support frame 40 to feed pan 39, but rather is attached via holding elements (not shown) with upper sieve 13 or lower sieve 12.

Via the swinging motion of lower sieve 13—which may swing opposite to upper sieve 12, for example—clean grain return floor 45, floor 28, feed pan 39, and the loss-measuring device are moved, so that all elements exert a conveying effect on the flow of crop material.

A flow of crop material composed of a grain/chaff mixture 47 is located on upper sieve 12 and lower sieve 13. Via the motion of sieves 12, 13, the heavier grains 49 fall through sieves 12, 13 onto the clean grain return floor. Due to the swinging motion of sieves 12, 13 in conjunction with air flow 37, the lighter weight chaff 48 and a few grains 49 are conveyed past the back end of sieves 12, 13 and in the direction of feed pan 39. In so doing, grains 49 that are still located in the crop material flow fall onto the loss-measuring device and are directed to tailings 27 via floor 28 in the manner described above.

It will be understood that each of the elements described above, or two or more together, may also find a useful application in other types of constructions differing from the types described above.

While the invention has been illustrated and described as embodied in a self-propelled agricultural harvesting machine with loss-measuring device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A self-propelled harvesting machine, comprising a cleaning device having sieves; a loss-measuring device for said sieves of said cleaning device; at least one sensor having a sensor surface and located at a back end of said cleaning device, said sensor being located at an end of said cleaning device behind at least one of said sieves such that a crop material that fails on the said sensor surface and is detected remains in the harvesting machine and is conveyed to a tailings device.

2. A self-propelled harvesting machine as defined in claim 1; and further comprising at least one rake which abuts at least one of said sieves and has a surface, said sensor surface being not parallel with the surface of said at least one rake and being tilted toward said cleaning device at a certain angle.

3. A self-propelled harvesting machine as defined in claim 1; and further comprising a sensor holder which determines an arrangement of said sensor and includes several functional sections which include at least one opening, at least one fastening element and at least one guide element.

4. A self-propelled harvesting machine as defined in claim 3, wherein said at least one opening accommodates said sensor.

5. A self-propelled harvesting machine as defined in claim 3; and further comprising a chaff spreader having a feed pan, said at least one fastening element attaching said sensor holder to said feed pan of said chaff spreader.

6. A self-propelled harvesting machine as defined in claim 3, wherein said guide element is configured as a stepped guide element.

7. A self-propelled harvesting machine as defined in claim 3; and further comprising an extension mat located on at least one end of said guide element.

8. A self-propelled harvesting machine as defined in claim 1; and further comprising a cleaning fan which produces an air flow that flows over said loss-measuring device.

9. A self-propelled harvesting machine as defined in claim 1, wherein said sensor has a length and a width divided into individual partial sensor services over a width of said sieve.

10. A self-propelled harvesting machine as defined in claim 3, wherein said sensor surface and said sensor holder are connected with each other in a manner selected from a group consisting of detachably connected and non-detachably connected.

11. A self-propelled harvesting machine as defined in claim 3; and further comprising a connection of said sensor surface with said sensor holder and configured as an injection-molded connection.

12. A self-propelled harvesting machine as defined in claim 3, wherein said sensor surface and said sensor holder are connected with one another in an elastic and vibration-damped manner.

13. A self-propelled harvesting machine as defined in claim 3, wherein said sensor holder includes tapers in a material located circumferentially around said sensor surface.
